(19) United States
(12) Patent Application Publication
(10) Pub. No.: US 2013/0174817 A1
(43) Pub. Date: Jul. 11, 2013

(54) EXHAUST SYSTEM AND METHOD FOR AN INTERNAL COMBUSTION ENGINE

(71) Applicants: Paul E. Reinke, Rochester Hills, MI (US); Julie N. Brown, Dearborn, MI (US)

(72) Inventors: Paul E. Reinke, Rochester Hills, MI (US); Julie N. Brown, Dearborn, MI (US)

(73) Assignee: Julie N. Brown, Dearborn, MI (US)

(21) Appl. No.: 13/344,145

(22) Filed: Jan. 5, 2012

(51) Int. Cl. F02B 47/08

(52) U.S. Cl. 123/568.21

(57) ABSTRACT

An exhaust system and method for optimizing the efficiency of an internal combustion engine from which spent gas emerges. Spent gas is fed to an exhaust housing that accommodates a venturi. Part of the spent gas travels through the venturi and part travels outside the venturi. Across the mouth of the venturi sits a directing valve plate that can be moved, thereby opening or closing the path through the venturi. Some of the spent gas is reflected rearwardly from the venturi and thus reenters the cylinder. Upon doing so, the reflected spent gas occupies some of the space above the piston, lowers combustion pressure and reduces the velocity and pressure of the gas flow emerging therefrom.

### BACKGROUND OF THE INVENTION

One aspect of the invention relates to an exhaust system that is coupled with an internal combustion engine for improving engine efficiency over a range of engine loads and speeds.

(1) Field of the Invention

Conventional internal combustion explosion engines may not achieve a desired level of volumetric efficiency, fuel economy or a satisfactory level of benign emissions over a range of engine speeds. Such characteristics are attributable to low pressure in the intake duct, insufficient quantities of fresh gas introduced into the cylinders, and the adverse effect of products of combustion remaining in the combustion chamber.

(2) Description of Related Art

An internal combustion engine's performance is sometimes illustrated by a power-volume (P-V) curve. Pressure-volume diagrams have a vertical axis that represents the pressure in a cylinder. The horizontal axis represents the “swept” volume of the cylinder. It is known that a preferred cycle has a minimal pumping loop. Ideally, gas exchanges from the intake manifold into the cylinder and from the cylinder to the exhaust manifold after combustion happen without associated losses. In practice this is rarely realized. Work is always expended in drawing fresh gases into a cylinder and expelling exhaust gases therefrom.

Under a full engine load, the exhaust manifold pressure will exceed that of the ambient atmosphere. In most cases, a significant portion of the work done by an engine is dissipated in overcoming pumping and frictional losses. Often, spark-ignited engines exhibit poor efficiency under part load conditions compared to their efficiency under full load operational conditions.

If at a given level of engine output the area of the pumping loop can be reduced, less work will be dissipated in the gas exchange process. In such cases, fuel requirements will be reduced and improved efficiency may result.

One known method for improving part load fuel economy involves exhaust gas recirculation (EGR) systems. EGR systems introduce exhaust gases into the fresh air-fuel mixture before combustion. Exhaust gases in the cylinder occupy cylinder volume that would otherwise be occupied by un-burned air-fuel mixture. But this restricts maximum engine output.

Prior solutions also include harnessing turbo-compressors, supplementary flap valves, variable valve timing, ducts of variable length, throttle controls which open and close intake ducts, exhausts with resonance chambers, and electronically controlled exhaust valves. Such solutions often involve expensive and technically complex arrangements, and are sub-optimal. They may produce maximum power levels at high engine speeds, but at the expense of power output at low engine speeds. Also, power may be delivered irregularly and at a high fuel burn rate.

Among the art considered in preparing this patent application is U.S. Pat. No. 6,269,806. This reference discloses an intake and exhaust device for improving the efficiency of an internal combustion engine. Each cylinder receives an air-fuel fresh gas mixture via an intake system with at least one intake valve. Spent gas emerges from the cylinders through an exhaust system that incorporates at least one exhaust valve. In the exhaust system, fins modify the direction, speed and pressure of the gas flow, some of which is “reflected” from downstream to upstream.

### BRIEF SUMMARY OF THE INVENTION

One aspect of the invention includes an apparatus and method for overcoming the limitations of prior approaches to optimizing engine performance.

A related object of one embodiment of the invention is to provide a device which enables an internal combustion engine volumetric efficiency to be achieved which is satisfactory over a range of engine speeds.

A further object is to provide a device which at each engine RPM enables a higher power to be achieved than known engines of equal displacement, with less fuel consumption and with less pollution than prior art approaches.

These and further objects are attained by a device that reconfigures the path followed by exhaust gases within an exhaust duct of an internal combustion engine.

By means of the device of the invention, the exhaust duct is given a specific configuration which for comparable suction or compressive forces, produces a greater gas velocity and hence a greater throughput than known exhaust ducts.

The consequent effects include better air-fuel mixing; an increase in the expelled spent gas flow; better volumetric efficiency over a range of engine speeds; an increase in power; an increase in torque; a reduction in fuel consumption; and reduced pollution.

When the device of the invention is positioned in the exhaust system, it enables the spent gas velocity to be increased towards the free air, so creating a greater vacuum for improved efficiency in cylinder emptying.

The exhaust device of the invention is applicable to most types of multiple stroke internal combustion engines.

In an exemplary embodiment, the inventive apparatus is situated within an exhaust system of an internal combustion engine. The apparatus optimizes engine efficiency and controls emissions over a range of engine loads and speeds. To appreciate a representative embodiment of the invention, consider an engine with at least one cylinder within which a piston moves. Each cylinder receives an air-fuel fresh gas mixture, burns the air-fuel fresh gas mixture to produce a spent gas, and expels the spent gas from each cylinder to the exhaust system.

In one embodiment, the exhaust system has an exhaust housing with an entry portal through which all spent gas passes. Optionally, a pipe is supported within the exhaust housing. Between the exhaust housing and the pipe is a passage. All exhaust gas passes through the pipe or the passage in a manner and with consequences to be described.

A venturi is located in the exhaust housing, and optionally supported within the pipe. The venturi has a bell-shaped inlet end, a throat and an outlet end. Under the influence of a directing valve plate, a proportion (C) of the spent gas accelerates through the venturi and a proportion (P) of the spent gas travels through the passage outside the venturi and within the exhaust housing.

The directing valve plate is movably positioned in the exhaust housing outside the venturi preferably proximate the inlet end of the venturi. In one embodiment, the directing valve plate is configured as a horseshoe-shaped plate with a pair of leg sections that straddle the venturi and an arch section that extends between the leg sections in the passage. The directing valve plate at least partially directs or reflects spent gas back into a cylinder which by-passes the venturi. Depending on its position, the directing valve plate causes some of the spent gas to pass through the passage rather than the venturi.

Without being bound by a specific theory of operation, it is thought that the venturi generates a reflective pressure pulse without a significant increase in backpressure that travels back into the cylinder. This phenomenon increases the amount of spent gas in the cylinder, reducing combustion temperature and engine pumping work, and thus improves fuel economy.

In one embodiment, the directing valve plate is fixedly mounted on a shaft that is mounted so that it may rotate about its longitudinal axis. Thus, the directing valve plate may move arcuately from a passage-blocked position through intermediate positions to a passage-open position. The shaft has ends that are rotatably supported by an inner wall of the exhaust housing. This enables the directing valve plate to be arcuately displaced as the shaft rotates about its longitudinal axis.

One aspect of the apparatus includes an actuator that lies in communication with and controls the arcuate displacement of the shaft. If desired, a sensor is in communication with the passages of the intake port, measures the air pressure in that port and generates a signal (S) indicative of engine load. The sensor feeds the signal (S) preferably to an electronic control unit (ECU) that in turn motivates an actuator so that the actuator may influence the angular displacement of the shaft and thus position of the directing valve plate. The sensor may be replaced or complemented by other signals for measuring engine load (e.g., air/cylinder event, fuel/cylinder event, injector pulse width, average cylinder pressure), engine speed or a sensor that generates a signal (B) that is indicative of exhaust backpressure.

Directing valve plate positioning influences the proportion (C) of spent gas passing through the venturi and the proportion (P) which travels through the passage in response to the signal (S) or (B).

The venturi and the directing valve plate generate a back pressure pulse and modify the pressure and flow rate of the spent gas so as to promote the efficiency of cylinder occupation by the air-fuel fresh gas mixture, the temperature of combustion and spent gas evacuation from the cylinder. Increased temperature of combustion helps reduce the production of pollutants, especially when the engine is cold. This phenomenon is at least partially explained by engines releasing most of their contaminants during the first few minutes of their start-up, before a typical catalytic converter begins working effectively because the chemical reactions that clean exhaust gases do not become active until the converter heats to about 150 degrees centigrade. In conventional exhaust systems, this warming process may take as long as a few minutes. Following prior art approaches, during those initial few minutes, contaminants may pass through the exhaust system relatively untouched. When the engine is cold, increased temperature of the exhaust gas and catalyst helps reduce the amount of pollutants vented to the atmosphere.

### BRIEF DESCRIPTION OF THE SEVERAL VIEWS OF THE DRAWINGS

FIG. 1 is a schematic cross sectional view of an engine with intake and exhaust valves, the exhaust valve lying in communication with an exhaust housing that accommodates a venturi, exhaust gases and an exhaust gas directing valve plate;

FIG. 2 is a view of the engine of FIG. 1, illustrating reflected exhaust gas flow that is redirected by the exhaust gas directing valve plate;

FIG. 3 is a quartering perspective view of the exhaust housing and directing valve plate;

FIG. 4 is a perspective and sectioned view of the exhaust gas directing valve plate in combination with a venturi lying within the exhaust housing;

FIG. 5 is an end view of an embodiment of the housing with the directing valve plate closed taken from the line 5-5 of FIG. 1;

FIG. 6 represents system components and exhaust gas flows in a representative arrangement;

FIG. 7 is an illustrative diagram of system components, sensors and representative signal flow paths;

FIG. 8 is an exemplary logic flow chart; and

FIGS. 9A-9E are illustrative graphs of valve position versus brake specific fuel consumption.

### DETAILED DESCRIPTION OF THE INVENTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

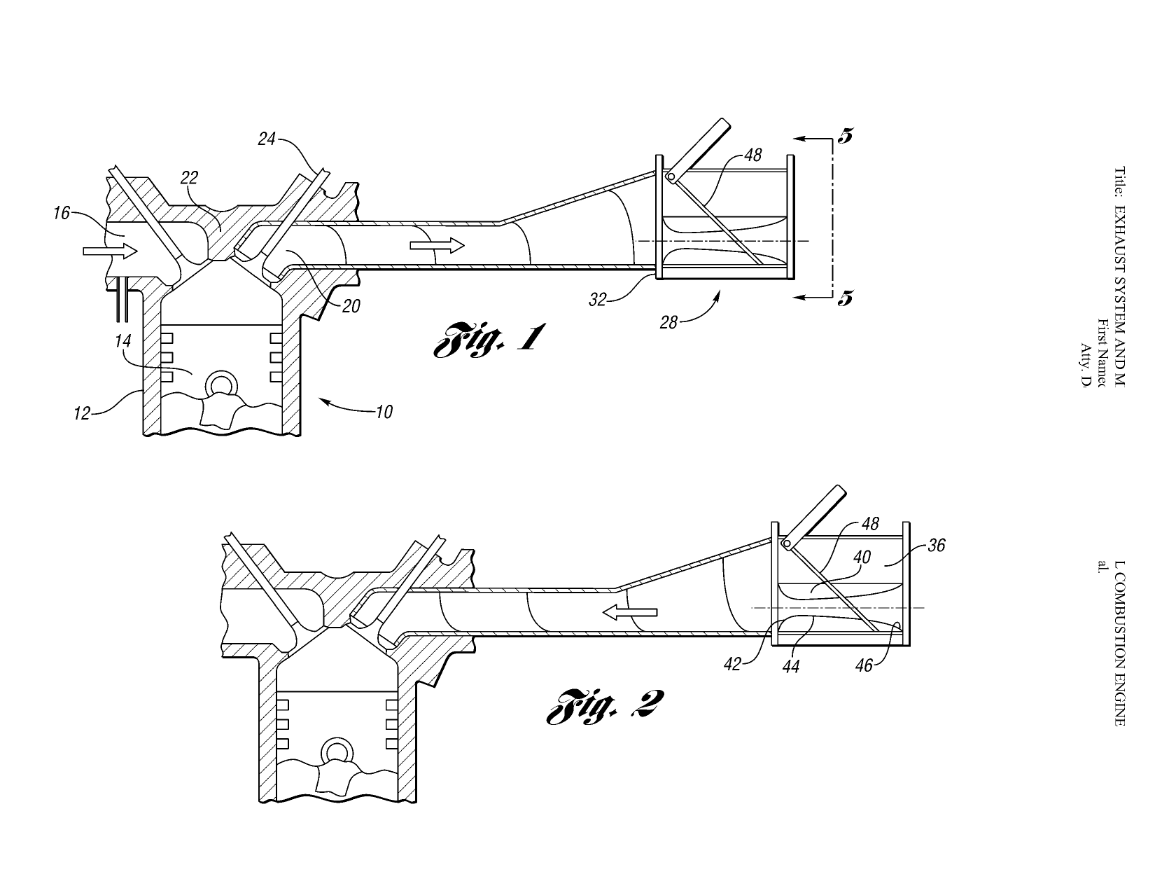

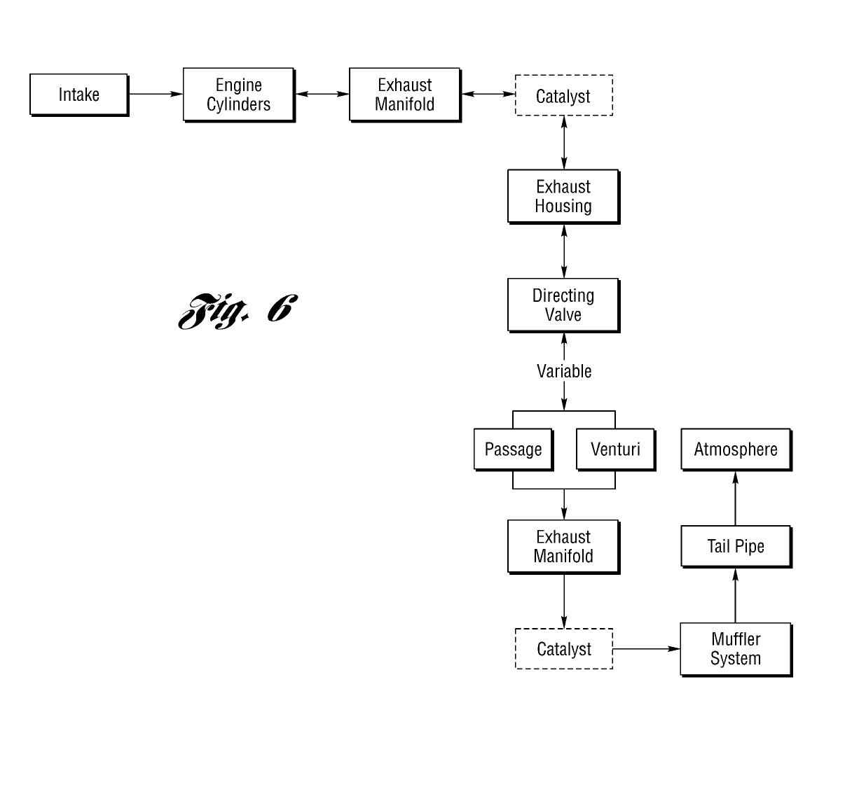

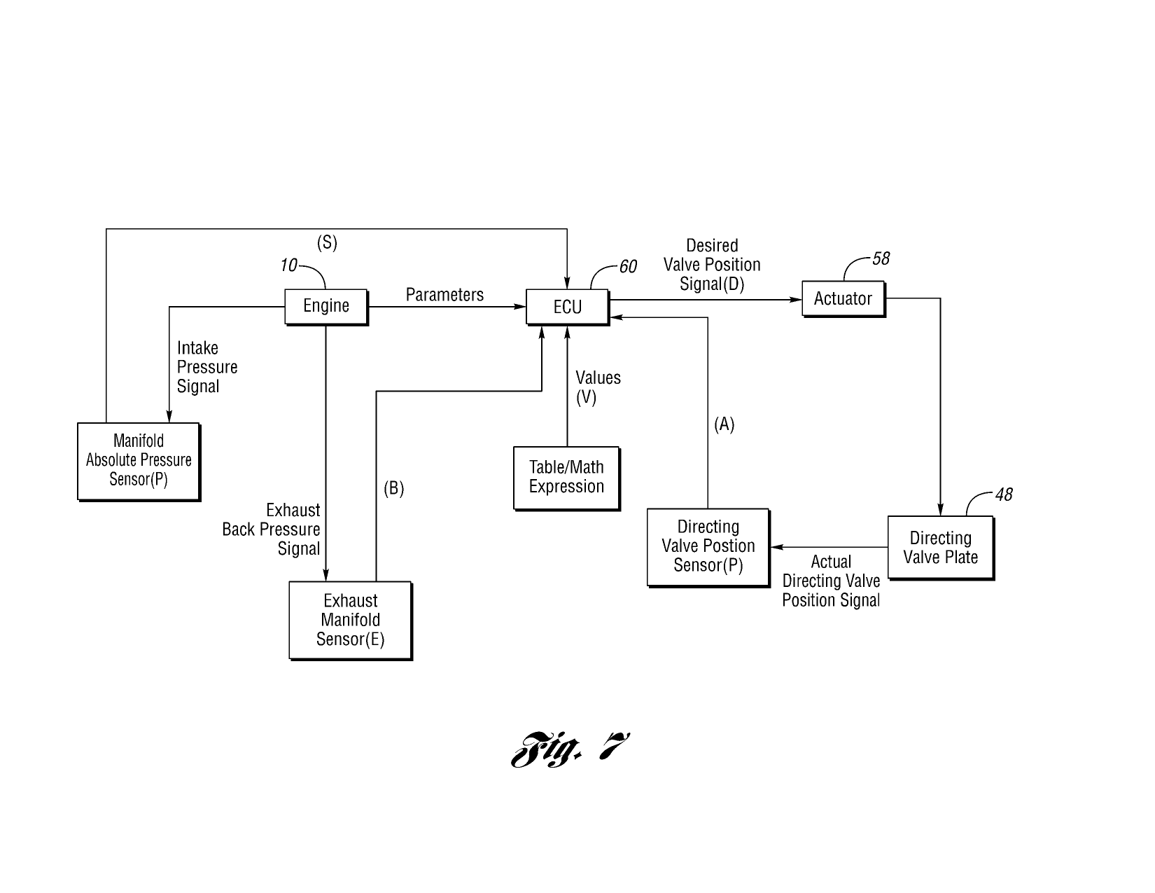

In FIGS. 1-5, an illustrative internal combustion four-stroke engine 10 is depicted, although the invention is not so limited. It has one or more cylinders 12, of which only one is depicted, within each of which a representative piston 14 moves. The cylinder head 22 houses one or more intake ducts 16 for introducing an air-fuel mixture into the cylinder 12. At least one exhaust duct 20 allows spent gas to be expelled from the cylinder 12 through one or more valves 24 in the cylinder head 22.

In one embodiment of the invention, operationally associated with one or more of the exhaust ducts 20 there is an exhaust device 28 that modifies the velocity and flow path of spent gas flow within the duct 20. In a manner to be described below, the exhaust device 28 redirects and increases the average speed of gas of flow across a section of and within the exhaust duct 20.

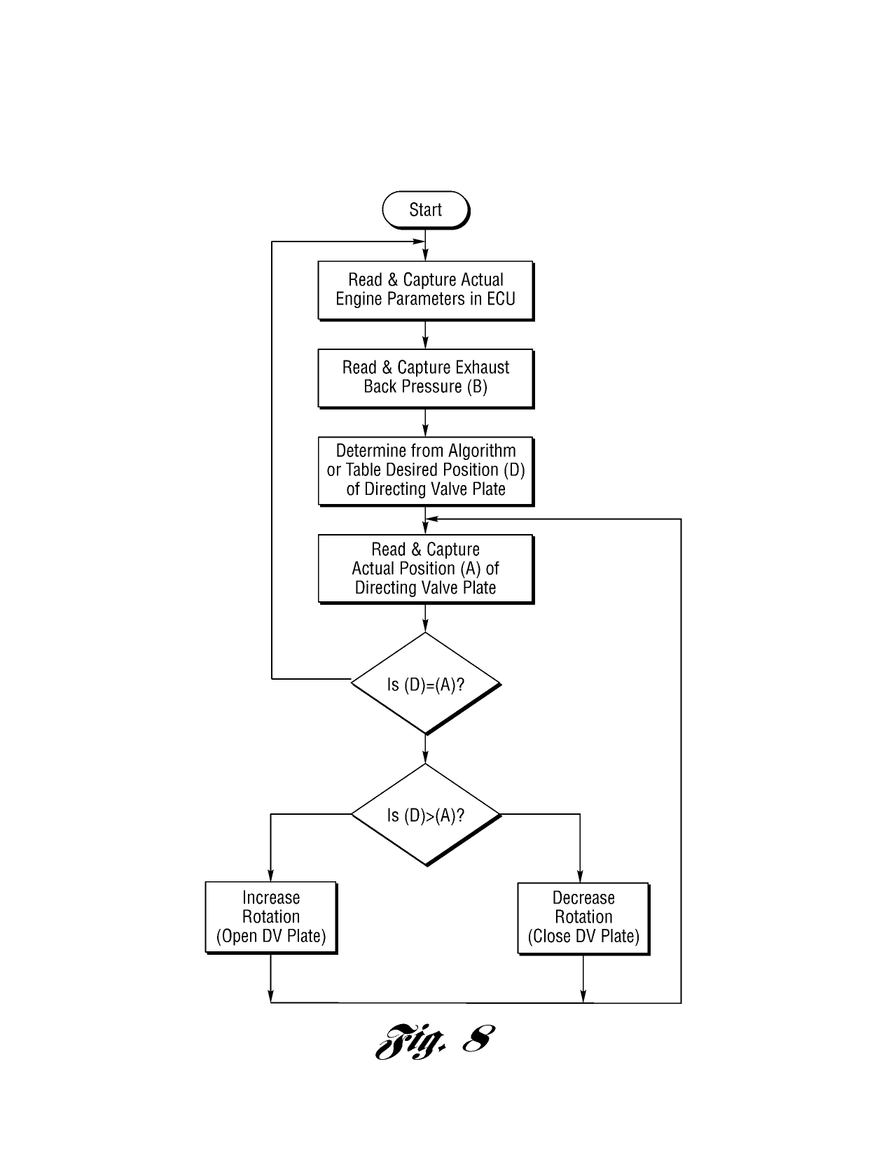

FIGS. 1-4 show one embodiment of the exhaust device 28 of the invention in combination with the exhaust duct 20. This device 28 comprises, in one example, a cylindrical or semi-cylindrical housing 30 inserted axially into a seat 32 formed in the exhaust duct 20. The housing 30 can be formed integrally with the seat 32 (for example by casting) or it can be independent of the duct 20 and be connected to it mechanically in a removable and interchangeable manner (with screws, bayonet coupling or the like) or be fixed (for example by welding). The exhaust device 28 may optionally be coupled to a catalytic converter (FIG. 6) or be integral therewith.

The exhaust device 28 can be positioned at any point along the path of the spent gas from the engine 10, depending on the geometry, the displacement and hence the type of engine with which it is associated. Its position along the path, i.e. closer to or further from the exhaust valve 24, enables different engine responses to be obtained at different RPM It can also be applied to engines operating at atmospheric pressure, or to boosted engines (with turbo-compressors or positive displacement compressors), thereby improving engine efficiency.

Reference will now be made primarily to FIGS. 1-4 which show one embodiment of the device 28 of the invention that is positioned in the exhaust system 20 of an internal combustion engine. An illustrative embodiment has an exhaust housing 30 with an entry portal 32 through which all spent gas passes. Optionally, a pipe 34 is supported within the exhaust housing 30. A passage 36 is defined between an inner wall 38 of the exhaust housing 30 outside the pipe 34. A venturi 40 is located within housing 30 and/or the pipe 34. The venturi 40 has a bell-shaped inlet end 42, a throat 44 and an outlet end 46.

A proportion (C) of the spent gas travels through the venturi 40 and a proportion (P) of the spent gas moves through the passage 36. A directing valve plate 48 is positioned in the exhaust housing 30 preferably proximate the inlet end 42 of the venturi 40. In one embodiment, the directing valve plate 48 has a pair of leg sections 50, 52 (FIG. 5) that straddle the pipe 34 or the venturi 40 alone if there is no pipe 34. An arch section 54 extends between the leg sections 50, 52 in the passage 36. Depending on its position, the directing valve plate 48 partially or completely blocks gas flow along the passage 36, and allows the remainder of the spent gas (C) to pass through the venturi 40.

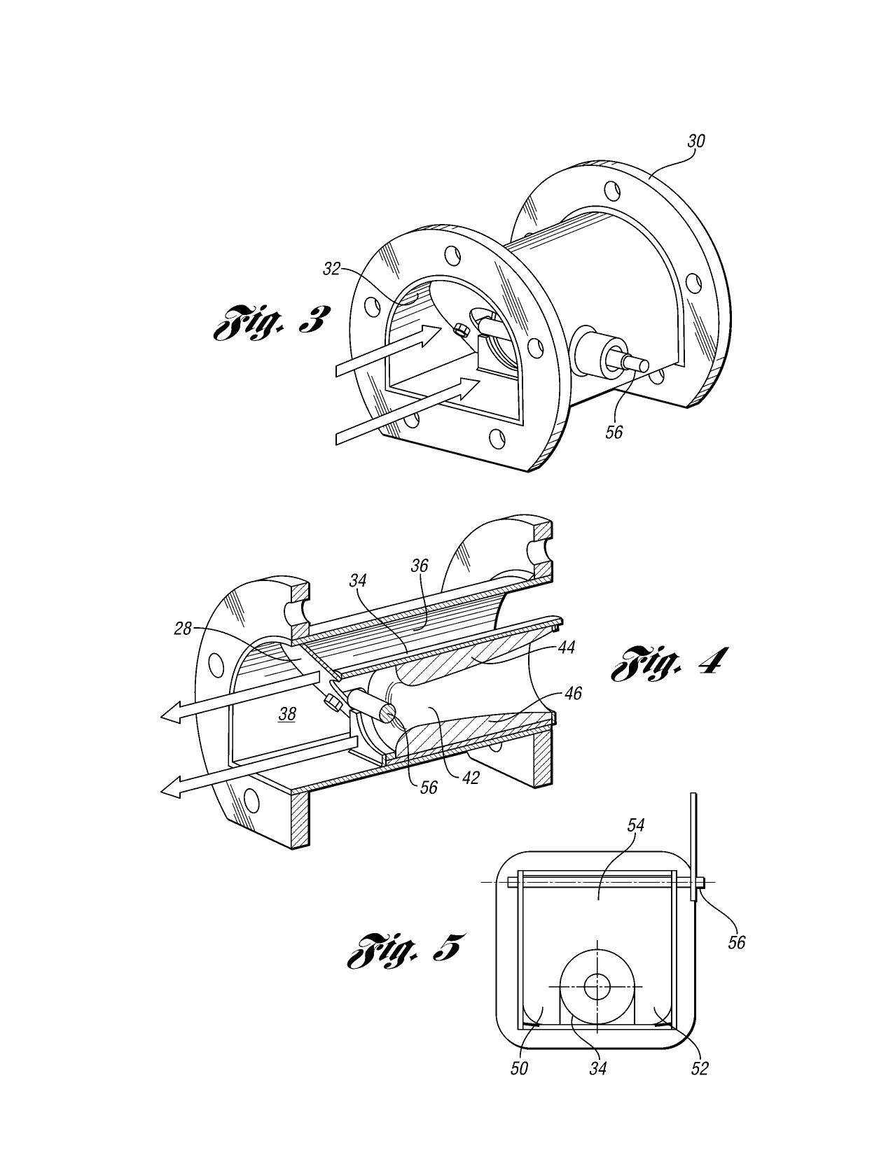

It is thought that the venturi 40 generates a reflective pressure pulse (FIG. 2) that is propagated from downstream to upstream through the spent gas stream escaping from the cylinder 12 without a significant increase in backpressure. The pulse travels back into the cylinder 12, thereby increasing the amount of spent gas in the cylinder 12. This reduces combustion temperature and engine pumping work, thus improving fuel economy.

The directing valve plate 48 is fixedly mounted on a shaft 56 so that the directing valve plate 48 may pivot from a passage-blocked position through intermediate positions to a passage-open position. The shaft 56 has ends that are supported by an inner wall 38 of the exhaust housing 30 so that the plate 48 is arcuately displaceable with the shaft 56 as the shaft 56 rotates about its longitudinal axis.

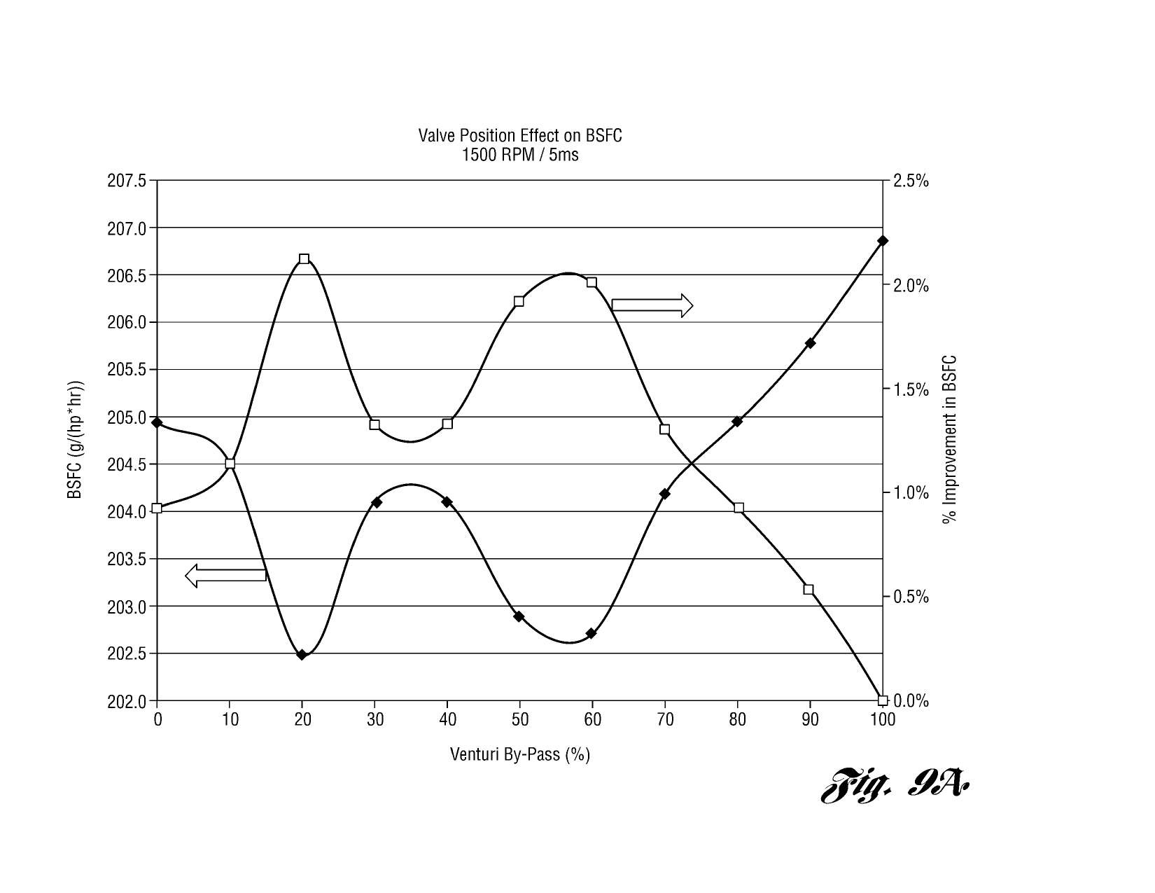

Optionally, an actuator 58 (FIG. 7) lies in communication with the shaft 56 and thus the directing valve plate 48. A sensor (P) generates a signal (S) indicative of engine load and feeds the signal to an electronic control unit 60 and then to the actuator 58. The actuator 58 influences angular displacement of the shaft 56 and thus the position of the directing valve plate 48. In an alternate embodiment, a sensor (E) may monitor exhaust backpressure within the exhaust system 20 as well as or instead of engine load. That sensor (E) communicates a signal (B) to the ECU 60 and then to the actuator 58.

Under the influence of the actuator 58 and thus the directing valve plate 48, the proportion (C) of spent gas passing through the venturi 28 to that (P) which travels through the passage 36 is controlled in response to the signal (S), the signal (B), or both.

The venturi 40 and the directing valve plate 48 modify the pressure and flow rate of the spent gas so as to increase the efficiency of combustion within the cylinder of the air-fuel fresh gas mixture, lower the temperature of combustion and retard spent gas evacuation from the cylinder.

During engine operation, hot spent gas passes through the exhaust device 28. After initial gas evacuation from the cylinder 12 as a result of high initial pressure upon opening the exhaust valve 24, the venturi within exhaust device 28 causes this gas to undergo a velocity increase towards the free end 46, hence generating a strong vacuum in the exhaust duct 20 and cylinder 12.

Thus spent gas is “reflected” by the venturi 40 in pressure pulses towards the cylinder 12 (FIG. 2). Without wishing to be bound by a particular theory, these reflective pressure pulses originate from an area close to or at the throat 44 of the venturi 40. They pass through the exhaust device 28 from downstream to upstream through the exhaust housing 30, to be decelerated and/or halted by the spent gas as it leaves the cylinder 12. In some cases, there may be multiple pressure pulses that are reflected backwardly during one piston stroke.

This prolongs the spent gas extraction stage and produces a more consistent emptying of the cylinder 12, and thus facilitates its filling with fresh charge during the next cycle.

It can thus be appreciated that the exhaust device 28 improves overall engine efficiency. The device 28 increases engine performance while reducing fuel consumption and atmospheric pollution. Its simple construction makes the device 28 economical to build and reliable over long periods of operational use.

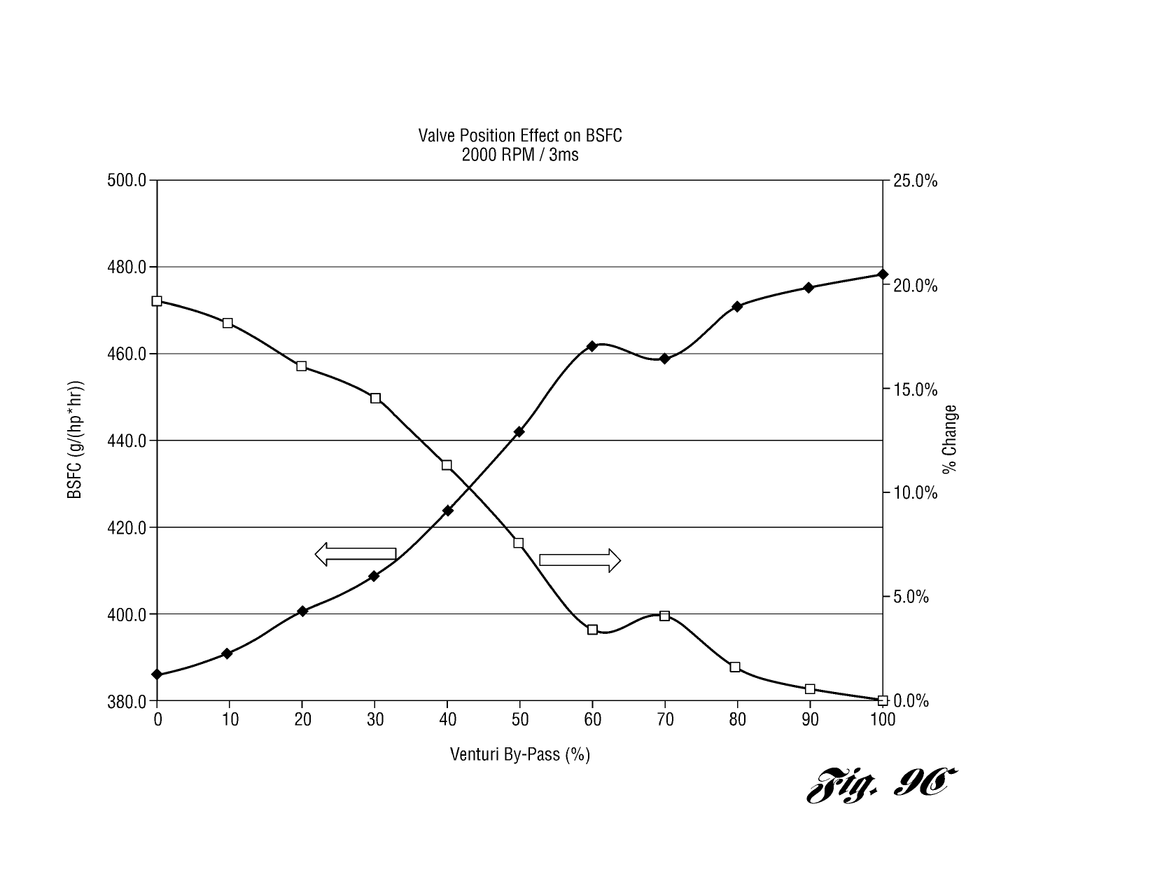

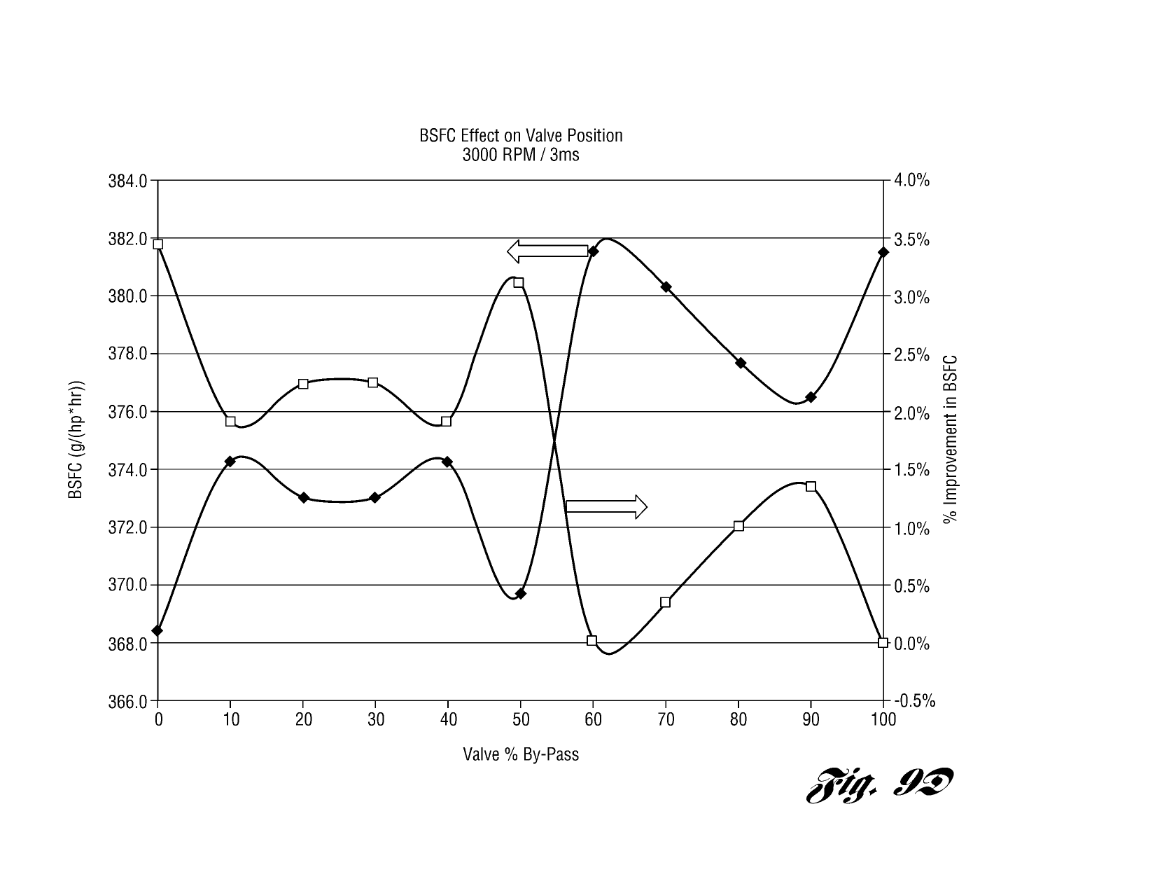

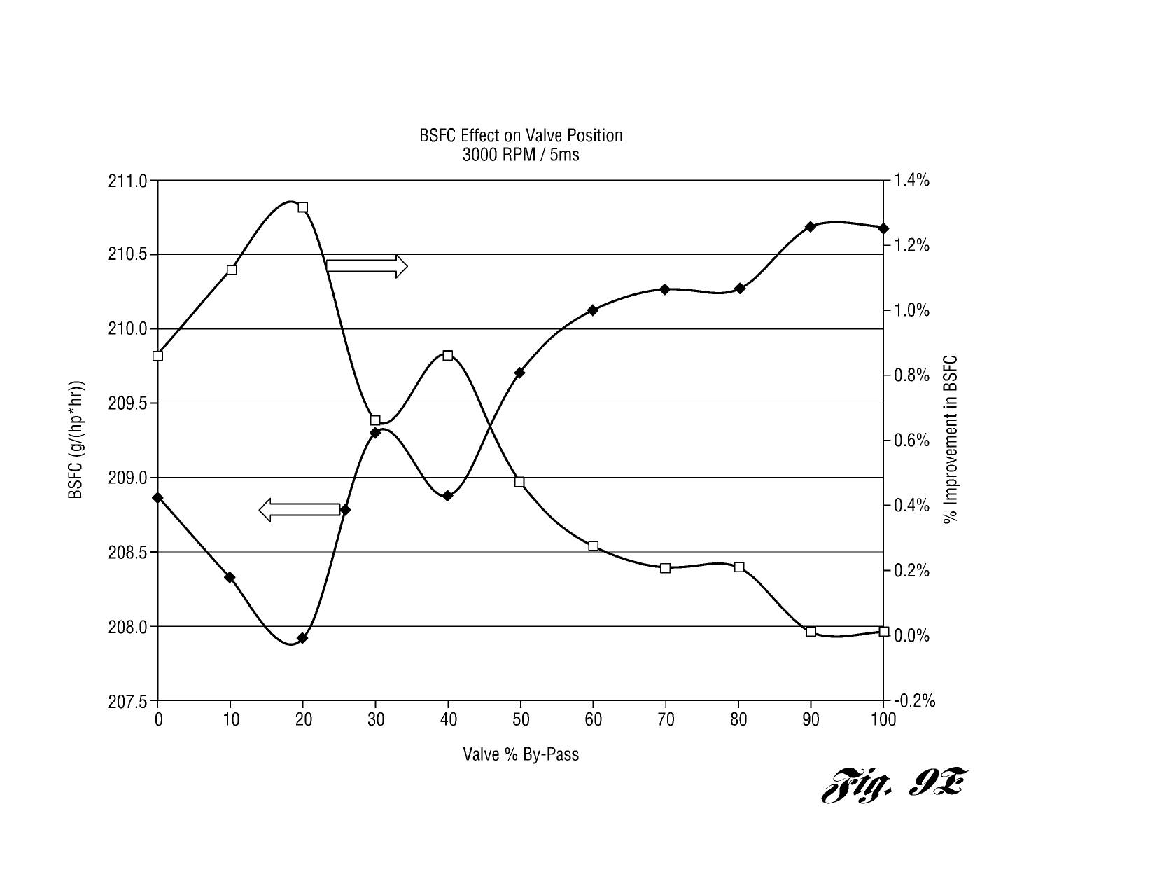

In various experiments, the performance of an embodiment of the inventive device 28 was observed. Representative graphs are illustrated in FIGS. 9A-9E. In each graph, the abscissa represents directing valve plate position, with 0 indicating that the directing valve plate 48 is fully closed. The ordinate is brake specific fuel consumption (BSFC), which is fuel consumption rate divided by gross power. In general, the smaller the value, the better, other things being equal. BSFC allows the fuel efficiency of different reciprocating engines to be directly compared.

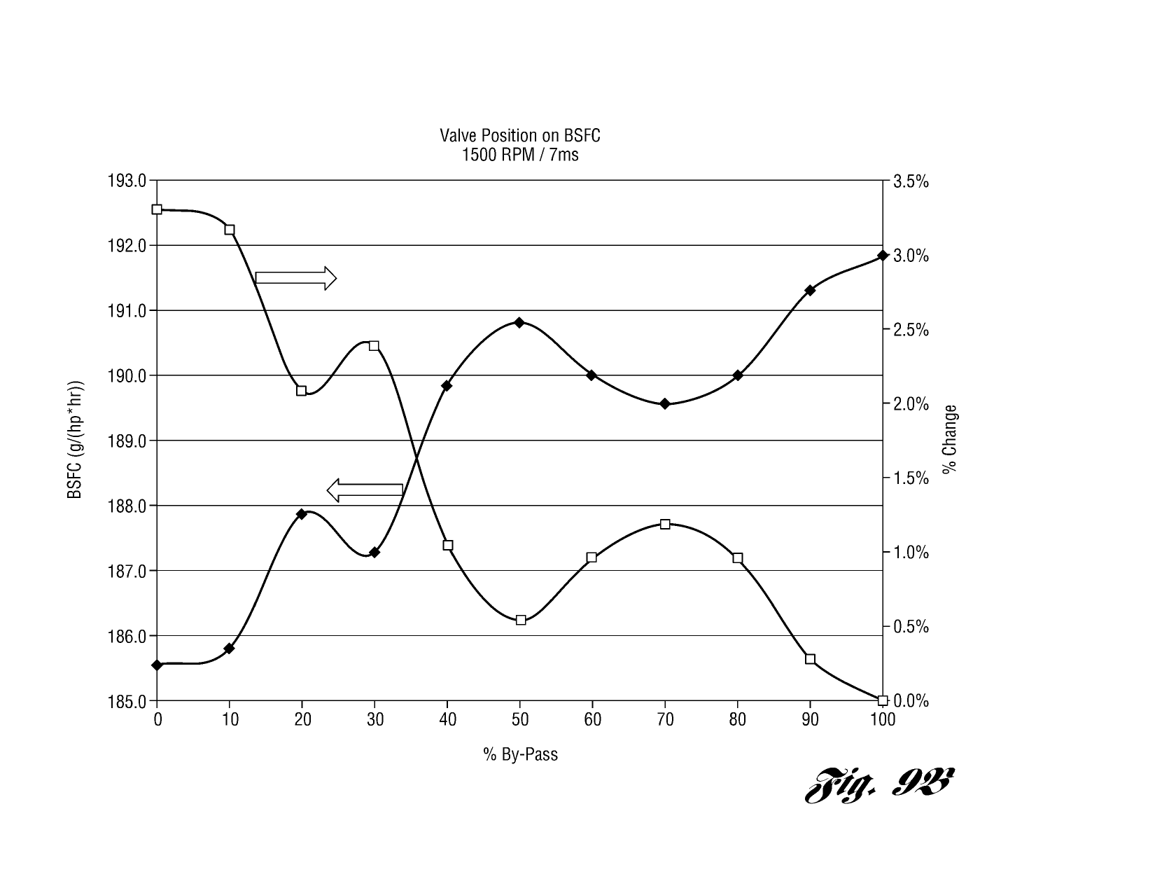

One test was run at a fixed engine speed (1500 RPM) and a fixed fuel rate (a 5 millisecond fuel injector pulse per intake event) (FIG. 9A). Injector pulse width was used as a load variable. In one approach, the electronic control unit (ECU) 60 includes a table or mathematical expression for a range of speeds and loads (FIG. 8).

The graphs (FIGS. 9A-9E) shows the effect of the directing valve plate 48 on engine torque under various conditions. HP equals RPM times torque. Since in a given graph, RPM and fuel rate are constant, the results show that torque increased. In FIG. 9B, for example, the observed 3 percentage improvement is about what one would expect for a vehicle fuel economy test with the inventive device installed.

One plot (FIG. 9B) shows that the maximum torque is experienced with the by-pass directing valve plate 48 fully closed and all the flow going through the venturi 28. This speed and load represents what would be encountered during a vehicle's moderate acceleration event, which is about 30% greater than road load. Although not compared to baseline performance, having the directing valve plate 48 fully open approximates that condition.

One embodiment tested was most effective at low speeds and light loads. But that embodiment has shown efficiency improvement over various engines speeds and load ranges. Comparing the graphs (FIGS. 9A-9E) run at a fixed fuel/intake event (fuel injector pulse width) and engine RPM supports this inference.

Returning to FIG. 9A, at 1500 RPM and 5 msec pulse width with 20% venturi by-pass, over 2% of improvement in BSFC was observed. As mentioned earlier, when the fixed fuel rate per cylinder was increased to 7 msec (FIG. 9B), the improvement increased to 3¼%. At a 5 msec pulse width, if the engine speed is doubled to 3000 RPM (FIG. 9E), a positive improvement in BSFC is still realized.

In operations below road load, some large gains in BSFC have been realized. At 2000 RPM and a 3 msec pulse width with all the flow through the venturi, over 20% improvement has been observed. At the same fixed fuel rate per cylinder, if the engine speed is increased to 3000 RPM (FIG. 9D), an improvement of 3.5% in BSFC is still achieved.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. An exhaust system of an internal combustion engine for optimizing engine efficiency and controlling emissions over a range of engine loads and speeds, the exhaust system comprising:
an exhaust housing downstream of an exhaust port of the engine, the exhaust housing having an entry portal through which all spent gas passes;
a venturi located within the exhaust housing;
a passage within the exhaust housing outside the venturi; and
a directing valve plate positioned in the passage, the directing valve plate directing some spent gas along the passage while by-passing the venturi, and allowing some spent gas to pass through the venturi, thereby generating a reflective pressure pulse without a significant increase in backpressure.

2. The exhaust system of claim 1, further including:
a shaft about which the directing valve plate may pivot from a passage-blocked position through one or more intermediate positions to a passage-open position.

3. The exhaust system of claim 2, in which the shaft has ends that are supported by an inner wall of the exhaust housing, the directing valve plate being affixed to and arcuately displaceable with the shaft as the shaft rotates about its longitudinal axis.

4. The exhaust system of claim 3, including:
an actuator in communication with the shaft;
a sensor (P) in communication with an intake port that generates a signal (S) indicative of engine load, the sensor feeding the signal (S) to an electronic control unit and then to the actuator, the actuator influencing rotational displacement of the shaft and thus the position of the directing valve plate so that the proportion (C) of the spent gas passing through the venturi to the amount (P) which travels through the passage is controlled in response to the signal (S) and the distribution of spent gas is influenced by the directing valve plate; and
the venturi and the directing valve plate thereby modifying the pressure and flow rate of the spent gas so as to promote the efficiency of engine operation.

5. An exhaust system of claim 4, wherein the venturi tapers in the direction of the spent gas incident flow through the exhaust housing.

6. An exhaust system for an internal combustion engine for optimizing the efficiency of the engine, comprising:
a catalytic converter mounted in an exhaust system of the engine;
an exhaust housing connected to the catalytic converter, the housing having an entry portal through which all spent gas passes;
a pipe supported within the exhaust housing;
a passage within the exhaust housing outside the pipe;
a venturi located within the pipe; and
a shaft about which a directing valve plate may pivot from a passage-blocked position through an intermediate position to a passage-open position.

7. The exhaust system of claim 6, further including:
an actuator in communication with the shaft; and
a sensor (E) in communication with at least one cylinder that senses exhaust back pressure and generates a signal (B) indicative of exhaust back pressure, the sensor feeding the signal (B) to the actuator, the actuator influencing angular displacement of the shaft and thus the position of the directing valve plate;
so that the proportion (C) of spent gas passing through the venturi to that (P) which travels through the passage is controlled in response to the signal (B) and the distribution of spent gas is influenced by the directing valve plate; and
the venturi and the directing valve plate thereby modifying the pressure and flow rate of the spent gas so as to promote the efficiency of cylinder occupation by the air-fuel fresh gas mixture, the temperature of combustion and spent gas evacuation from the cylinder.

8. The exhaust system of claim 6, wherein movement of the directing valve plate is controlled in response to engine load and sensed back pressure.

9. The exhaust system of claim 6, wherein movement of the directing valve plate is controlled primarily in response to engine load.

10. An exhaust system of an internal combustion engine for optimizing engine efficiency and controlling emissions over a range of engine loads and speeds, the engine having at least one cylinder within which a piston moves, each cylinder receiving an air-fuel fresh gas mixture, combusting the air-fuel fresh gas mixture to produce a spent gas, expelling the spent gas from each cylinder to the exhaust system, the exhaust system comprising:
an exhaust housing having an entry portal through which all spent gas passes;
a venturi located within housing;
a passage within the exhaust housing outside the venturi;
a directing valve plate positioned in the exhaust housing proximate an inlet end of the venturi, the directing valve plate having a U-shaped plate with a pair of leg sections that straddle the pipe and an arch section that extends between the leg sections in the passage, the directing valve plate at least partially directing spent gas so that the spent gas by-passes the venturi, and at least partially allowing some of the spent gas to pass through the venturi, the venturi generating a reflective pressure pulse without a significant increase in backpressure that travels back into the cylinder, thereby increasing spent gas in the cylinder, reducing combustion temperature and engine pumping work, thus improving fuel economy;
a shaft about which the directing valve plate may pivot from a passage-blocked position through intermediate positions to a passage-open position, the shaft having ends that are supported by an inner wall of the exhaust housing, the directing valve plate being affixed to and arcuately displaceable with the shaft as the shaft rotates about its longitudinal axis;
an electronic control unit (ECU);
an actuator in communication with ECU and the shaft; and
a sensor (P) in communication with the passages of the intake port that measures the air pressure in that port and generates a signal (S) indicative of engine load, the sensor feeding the signal (S) to an electronic control unit and then to the actuator, the actuator influencing rotational displacement of the shaft and thus the position of the directing valve plate
so that the proportion (C) of the spent gas passing through the venturi to the amount (P) which travels through the passage is controlled in response to the signal (S) and the distribution of spent gas is influenced by the directing valve plate,
the venturi and the directing valve plate thereby modifying the pressure and flow rate of the spent gas so as to promote the efficiency of the cylinder occupation by the air-fuel fresh gas mixture, the temperature of combustion and spent gas evacuation from the cylinder.

11. An exhaust system of an internal combustion engine for optimizing engine efficiency and controlling emissions over a range of engine loads and speeds, the engine having at least one cylinder within which a piston moves, each cylinder receiving an air-fuel fresh gas mixture, combusting the air-fuel fresh gas mixture to produce a spent gas, expelling the spent gas from each cylinder to the exhaust system, the exhaust system comprising:
an exhaust housing having an entry portal through which all spent gas passes;
a venturi located within the housing;
a passage between the venturi and the housing;
a directing valve plate positioned in the exhaust housing proximate the inlet end of the venturi, the directing valve plate having a U-shaped plate with a pair of leg sections that straddle the pipe and an arch section that extends between the leg sections in the passage, the directing valve plate at least partially causing spent gas to by-pass the venturi, and at least partially allowing some of the spent gas to pass through the venturi, the venturi generating a reflective pressure pulse without a significant increase in backpressure;
a shaft about which the directing valve plate may pivot from a passage-blocked position through intermediate positions to a passage-open position, the shaft having ends that are supported by an inner wall of the exhaust housing, the directing valve plate being affixed to and arcuately displaceable with the shaft as the shaft rotates about its longitudinal axis;
an actuator in communication with the shaft; and
a sensor (E) in communication with at least one cylinder that senses exhaust back pressure and generates a signal (B) indicative of exhaust gas pressure, the sensor feeding the signal (B) to the actuator via an electronic control unit, the actuator influencing angular displacement of the shaft and thus the position of the directing valve plate
so that the proportion (C) of spent gas passing through the venturi to that (P) which travels through the passage is controlled in response to the signal (S) and the distribution of spent gas is influenced by the directing valve plate,
the venturi and the directing valve plate thereby modifying the pressure and flow rate of the spent gas so as to promote the efficiency of cylinder occupation by the air-fuel fresh gas mixture, the temperature of combustion and spent gas evacuation from the cylinder.

12. An exhaust system of an internal combustion engine for optimizing engine efficiency and controlling emissions over a range of engine loads and speeds, the exhaust system comprising:
an exhaust housing downstream of an exhaust port of the engine, the exhaust housing having an entry portal through which all spent gas passes;
a venturi located within the exhaust housing;
a passage between the exhaust housing and the venturi; and
a directing valve plate positioned in the passage, the directing valve plate causing some spent gas to by-pass the venturi, and allowing some spent gas to pass through the venturi, the venturi, the directing valve or both generating a reflective pressure pulse without a significant increase in backpressure that travels back into a cylinder of the engine, thereby influencing exhaust gas ratio, decreasing pumping loss, increasing the amount of spent gas in the cylinder and reducing combustion temperature, thus improving fuel economy.

13. The exhaust system of claim 12, wherein the engine has one or more banks of cylinders and has one directing valve plate for each bank.

14. The exhaust system of claim 12, wherein the directing valve plate is generally U-shaped so that it may sit astride the venturi in the passage.

15. The exhaust system of claim 12, further including an electronic control unit interposed between a sensor and an actuator that influences the directing valve plate.

16. The exhaust system of claim 1, wherein the venturi has a bell-shaped inlet, a throat and an outlet, a proportion (C) of the spent gas travelling through the venturi and a proportion (P) of the spent gas travelling through the passage.

17. The exhaust system of claim 16, wherein the directing valve plate is located proximate the inlet of the venturi.

18. A method for optimizing engine efficiency and controlling emissions over a range of engine loads and speeds in an internal combustion engine, the method comprising the steps of, not necessarily in the order recited:
passing all spent gas from a cylinder through an exhaust housing;
locating a venturi within the housing, a proportion (C) of the spent gas travelling through the venturi and a proportion (P) of the spent gas travelling outside the venturi; and
positioning a directing valve plate in the exhaust housing between the venturi and an inner wall of the housing, the directing valve plate causing at least some exhaust gas to by-pass the venturi, while spent gas to passes through the venturi, the venturi or the directing valve plate or both generating a reflective pressure pulse.
